(19) United States
(12) Patent Application Publication
(10) Pub. No.: US 2004/0138988 A1
(43) Pub. Date: Jul. 15, 2004

(54) Method to facilitate a search of a database utilizing multiple search criteria

(76) Inventors: Bart Munro, San Jose, CA (US); Ching-jye Liang, San Jose, CA (US); Krisela Rivera, San Jose, CA (US); Jennifer Kozenski, San Mateo, CA (US); Choon Chong, San Jose, CA (US); Paul Fu, San Jose, CA (US); Nicholas Posner, Menlo Park, CA (US); Matthew W. Mengerink, San Jose, CA (US); Farida Budiwarman, San Jose, CA (US); Sonya Liang, San Jose, CA (US); Sheila Goetzman, San Jose, CA (US); Elaine Fung, San Jose, CA (US); Shelley Koegler, San Jose, CA (US); Mike McCartney, Austin, TX (US); Kerry Clendinning, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/606,410

(22) Filed: Jun. 25, 2003

Related U.S. Application Data
(60) Provisional application No. 60/435,921, filed on Dec. 20, 2002.

(51) Int. Cl. G06F 7/00; G06F 17/30; G06F 17/60

(52) U.S. Cl. 705/37; 707/10

(57) ABSTRACT

A method and system to facilitate a search of a database utilizing multiple search criteria is provided. The method includes receiving first and second search criteria from a user and, presenting the user with an option selectively to include and exclude each of the first and second search criteria from a search query run against the database. In one embodiment, the database forms part of a web-based auction facility and the first and the second search criteria are associated with listings up for auction on the auction facility. The method may include rendering to the user a web page including a first search criteria section for receiving the first search criteria from the user; and a second search criteria section for receiving the second search criteria from the user.

### CROSS REFERENCE TO RELATED APPLICATION

The present application claims the benefit of the filing date of U.S. provisional application serial No. 60/435,921, filed Dec. 20, 2002.

### FIELD OF THE INVENTION

The present invention relates generally to purchasing products over a network-based commerce facility. More particularly, the invention relates to a system and a method to facilitate a search of a database via the Internet utilizing multiple search criteria.

### BACKGROUND

There is no question that the explosive growth of the Internet in recent years has changed classic business and economic models. One area in which this change has been noteworthy is in the auctioning of both new and used listings of products (goods and/or services) via the Internet. Participants may provide incremental bids to purchase the product and, upon a bid being successful, the purchaser then pays the amount he or she bid to claim title to the product. Although the products offered for sale are usually goods, it is to be appreciated that the bidding procedure may apply equally to services.

In order to locate products, a user may conduct a search of a database including all listings (including products and/or services) up for sale and/or auction using a keyword search. However, due to the large number of listings up for auction and/or sale on most network-based commerce facilities, the user is typically bombarded with a vast number of listings, many of which he or she may not be interested in. Accordingly, the user may wish to refine the search using further search criteria.

### SUMMARY OF THE INVENTION

In accordance with one aspect of the invention, there is provided a method to facilitate a search of a database utilizing multiple search criteria, the method including:

receiving first and second search criteria from a user; and

presenting the user with an option selectively to include and exclude each of the first and second search criteria from a search query run against the database.

The method may include conducting a search of the database utilizing the search query, the search query including at least one of the first and second search criteria as included by the user.

In certain embodiments, the method may include:

presenting a search interface to the user to receive the first and the second search criteria, the search interface providing the user with a limitation option to limit a scope of any search query including the first search criteria;

monitoring selection of the limitation option by the user; and

monitoring an indication from the user that indicates inclusion or exclusion of each of the first and second search criteria within the search query.

The database may form part of a network-based commerce facility. The network-based commerce facility may be a network-based auction facility and the first and the second search criteria are associated with listings up for auction on the auction facility. In certain embodiments, the network-based auction facility is a web-based auction facility, the method including rendering to the user a web page including a first search criteria section for receiving the first search criteria from the user; and a second search criteria section for receiving the second search criteria from the user, the second search criteria being associated with one of a plurality of categories in which listings are arranged.

The second search criteria section may provide a plurality of optional search criteria at least one of which is selectable by the user to define the second search criteria.

The method may include:

responsive to a first search request from the user, conducting a first search of the database to locate listings based on a first search query, wherein the first search query includes the first search criteria but not the second search criteria;

responsive to a second search request form the user, conducting a second search of the database to locate listings based on a second search query, wherein the second search query includes both the first and the second search criteria; and

responsive to a third search request from the user, conducting a third search of the database to locate listings based on a third search query, wherein the third search query includes the second search criteria but not the first search criteria.

The first search criteria may be a keyword that identifies at least one category of listings included within the database, and the second search criteria may identify at least one sub-category of the at least one category. In addition or instead, the second search criteria may be associated with a listing stored in the database.

In certain embodiments, the search interface maintains a display of each of the first and second search criteria, regardless of whether the first and second search criteria are each selected by the user to be included within the search query.

The invention extends to a system to facilitate searching of a database using multiple search criteria and to a machine-readable medium including instructions for executing any one of the methods described herein.

### BRIEF DESCRIPTION OF THE DRAWINGS

The present invention is illustrated by way of example, and not limitation, in the figures of the accompanying drawings in which like reference numerals refer to similar elements and in which:

FIG. 1 shows a schematic block diagram of an exemplary network-based commerce facility in the form of a web-based auction facility according to one embodiment of the present invention;

FIG. 2 shows a schematic diagram illustrating an exemplary database, maintained by, and accessed via a database engine server, that at least partially implements and supports searching a database using multiple search criteria;

FIG. 3 shows an exemplary category table of the database that includes attributes associated with a category of listings;

FIG. 4 shows a schematic block diagram of exemplary modules of a search engine for searching the database using multiple search criteria;

FIG. 5 shows a schematic screen shot of a search interface that allows a user to define multiple search criteria;

FIG. 6 shows a schematic flow diagram of a method, in accordance with one embodiment of the invention, for searching a database using multiple search criteria;

FIG. 7 shows a schematic block diagram of a method, in accordance with one embodiment of the invention, to identify search criteria defined by a user; and

FIG. 8 shows a schematic high-level block diagram of an exemplary machine in the form of a computer system.

### DETAILED DESCRIPTION

Described herein is a system and a method, in accordance with an aspect of the present invention, to facilitate searching a database of listings of products (good and/or services) up for auction and/or sale utilizing multiple search criteria. Throughout the following description specific details are set forth in order to provide a more thorough understanding of the invention. However, the invention may be practiced without these particulars. In certain instances, well known elements have not been shown or described in detail to avoid unnecessarily obscuring the present invention. Accordingly, the specification and drawings are to be regarded in an illustrative rather than a restrictive sense.

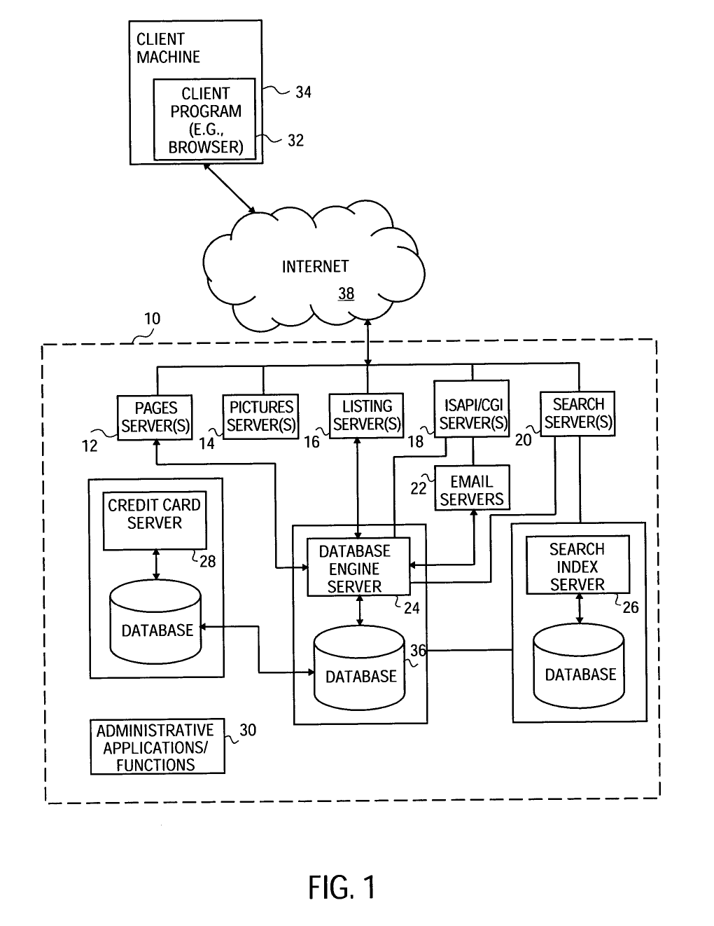

Referring to FIG. 1, there is shown a schematic block diagram of an exemplary network-based commerce facility in the form of a web-based auction facility according to one embodiment of the present invention. While exemplary embodiments of the present invention are described within the context of an auction facility, it will be appreciated by those skilled in the art that the invention will find application in many different types of computer-based, and network-based, commerce facilities including a fixed-price commerce network.

The auction facility includes an auction system 10 including one or more of a number of types of front-end servers, for example, page servers 12 that deliver web pages (e.g., markup language documents), picture servers 14 that dynamically deliver images to be displayed within Web pages, listing servers 16, ISAPI/CGI servers 18 that provide an intelligent interface to a back-end of the system 10, and search servers 20 that handle search requests to the system 10. A communication server including one or more e-mail servers 22 provides, inter alia, automated e-mail communications to users of the system 10. As described in more detail below, the search servers 20 use multiple search criteria selected by a user that allow a user selectively to combine a basic search with an attribute search and, optionally, search a particular category and/or group of categories.

The back-end of the auction system 10 may include a database engine server 24, a search index server 26 and a credit card database server 28, each of which maintains and facilitates access to a respective database. The back-end is also shown to include a number of administrative applications or functions 30 and the auction system 10 may be accessed by a client program 32, such as a browser (e.g., the Internet Explorer distributed by Microsoft Corp. of Redmond, Wash.) that executes on a client machine 34 and accesses the system 10 via a network such as, for example, the Internet 38. Thus, the client program 32 may define a web interface which communicates with a programmatic interface (e.g. one or more Application Program Interfaces (APIs)) running on the servers 12 to 20 of the system 10.

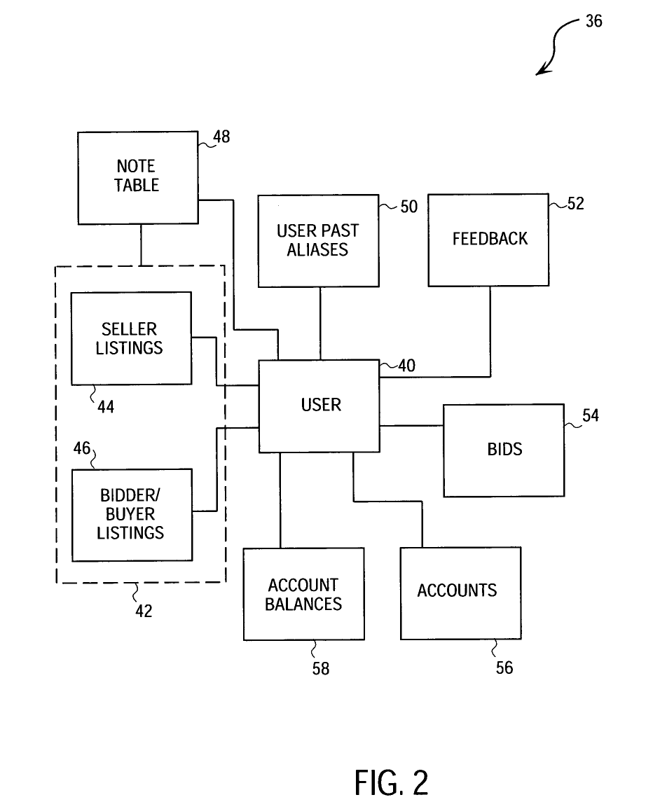

The database 36 (which may comprise several distributed databases) may store listings (including both items and services) that are up for auction and/or sale to users via the Internet 38. As shown in FIG. 1, the database 36 may be maintained by, and accessed via, the database engine server 24, which at least partially implements and supports the auction system 10. The database 36 may be a relational database, and include a number of tables having entries, or records, that are linked by indices and keys. In one embodiment, central to the database 36 is a user table 40 (see FIG. 2), which contains a record for each user of the auction system 10. A user may operate as a seller, a buyer, or both, within the auction system 10. The database 36 also includes listings tables 42 that may be linked to the user table 40. In one embodiment, the listings tables 42 include a seller listings table 44 and a bidder listings table 46. A user record in the user table 40 may be linked to multiple listings that are being, or have been, auctioned via the auction system 10. A number of other exemplary tables are also shown to be linked to the user table 40, namely a note table 48, a user past aliases table 50, a feedback table 52, a bids table 54, an accounts table 56, and an account balances table 58.

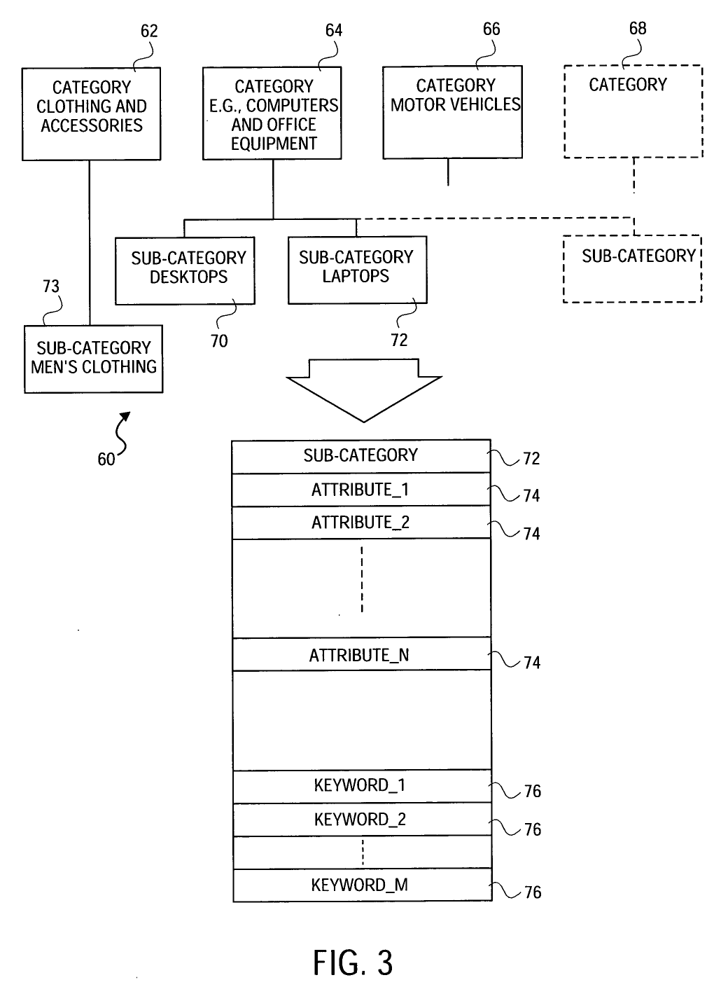

Referring in particular to FIG. 3 of the drawings, reference numeral 60 general indicates an exemplary arrangement of listings in the seller listings table 44. In one embodiment, listings of products up for sale and/or auction by the auction system 10 are arranged in categories 62 to 68. It is to be appreciated that the number of categories may vary depending upon the nature of the web-based auction facility. Exemplary categories that may be included are Clothing and Accessories 62, Computers and Office Equipment 64, Motor Vehicles 66, Arts and Antiques (not shown), Musical Instruments (not shown), Pottery and Glass (not shown), Real Estate (not shown), and the like. Each category 62 to 68 may include one or more sub-categories which may group listings in a particular category. For example, the Computers and Office Equipment category 64 may include a “Desktops” sub-category 70, a “Laptops” sub-category 72, a “Monitors” sub-category (not shown), and so on. Each sub-category 70, 72 may, in turn, include further details such as a plurality of attributes 74 as well as a plurality of keywords 76 which are associated with a particular category 62 to 68. For example, the Laptops sub-category 72 may include attributes 74 such as, processor speed, screen size, manufacturer, or any other attributes that may be associated with the particular listing. In one embodiment, the categories are arranged in a so-called “tree-structure” wherein sub-categories, and so on, may be provided.

It is to be appreciated that the number and type of attributes 74 associated with any category 62 to 68 may differ from one category to another. For example, as the category 62 relates to clothing, then a sub-category 73 may, for example, relate to men's pants and shorts and the attributes 74 may be associated with style, size, color, condition, minimum price, maximum price, and so on. Thus, the number and nature of the attributes 74 may differ from one embodiment to another and/or within the same embodiment.

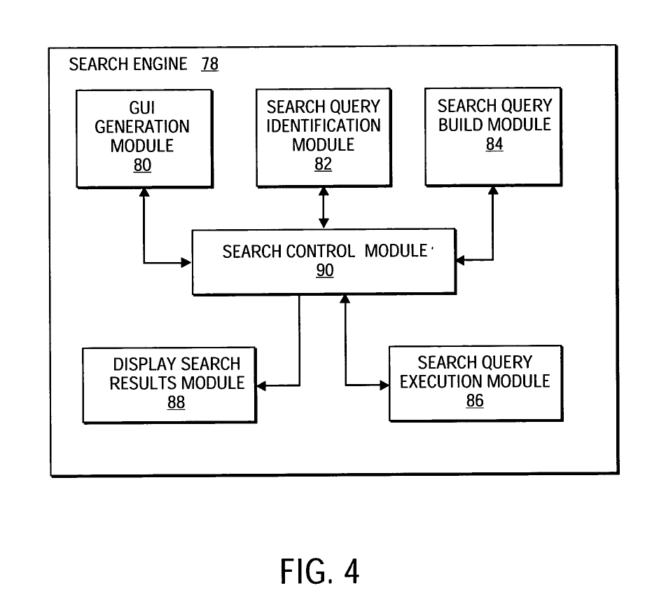

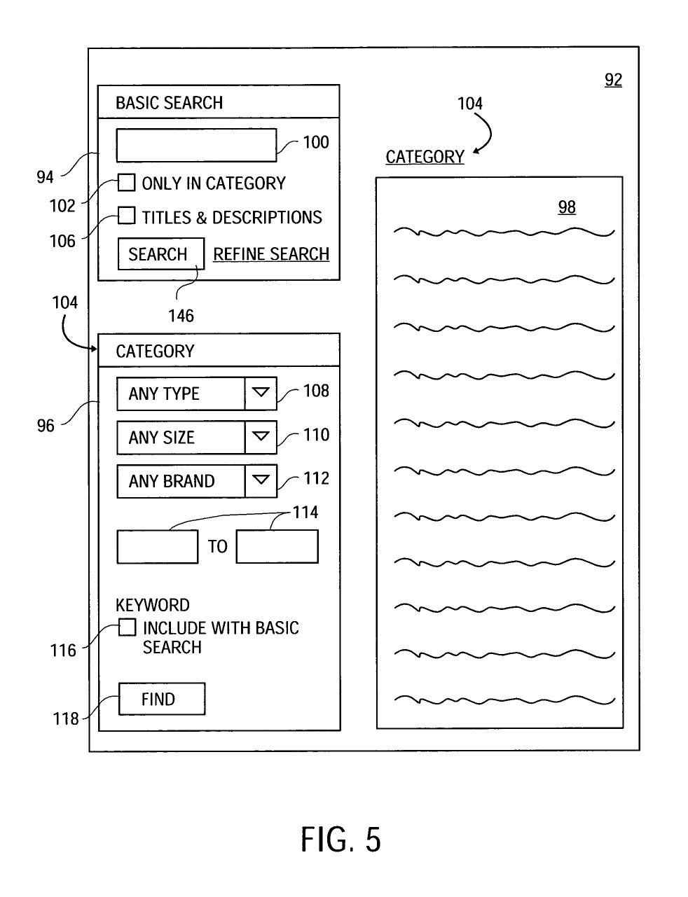

In order to facilitate searching the database 36 using multiple search criteria, the database engine server 24 may include a search engine 78 (see FIG. 4). In one embodiment, the search engine 78, as described in more detail below, includes a graphic user interface (GUI) generation module 80, a search query identification module 82, a search query build module 84, a search query execution module 86, and a display search results module 88. The modules 80 to 88 may be controlled by a search control module 90. In use, as described in more detail below, the search engine 78 monitors the selection and deselection of search criteria rendered to a user by the GUI generation module 80 in the form of a search interface 92 (see FIG. 5). The search interface 92 is typically in the form of an HTML page which is rendered via the Internet 38 to the client machine 34 (see FIG. 1).

Although the modules 80 to 90 are shown in FIG. 4 as part of the search engine 78, it is to be appreciated that the functionality may in other embodiments be carried out by other components of the system 10. For example, the display search results module 88 may communicate the search results to be displayed to the page and picture servers 12, 14 (see FIG. 1) which then render the results of the search to the client machine 34.

In one embodiment of the invention, the search interface 92 includes a first search criteria section in the form of a “Basic Search” box 94, a second search criteria section in the form of an “Attribute Search” box 96, and a display area 98 wherein listings (including goods and/or services) located during a particular search are presented or displayed to the user.

The Basic Search box 94 includes a first search criteria entry field, for example, text entry field 100 in which a user may enter a first search criteria (e.g., keyword) associated with the particular listing which he or she wishes to locate using the search engine 78 of the particular web-based auction facility. The Basic Search box 94 includes a check-box 102 which defines an identifier that allows a user to select or identify when he or she requires a search to be conducted only in a specific category. Accordingly, when the check-box 102 is checked, the search engine 78 only searches the particular category identified on the search interface 92, for example, as generally indicated by reference numeral 104. The Basic Search box 94 is also shown to include a check-box 106 that allows a user to search a first information type, for example, titles and descriptions in a particular search or query. Thus, by checking the check-box 106, the user may search titles and descriptions in the database 36 that include the particular keyword/search criteria entered in the entry field 100.

The Attribute Search box 96 includes a second information type, for example, attributes 108 to 114. The attributes 108 to 114 define optional search criteria that may be selected by the user as second search criteria. In one embodiment, the attributes 108 to 112 include dropdown menus and the attribute 114 allows a user to enter a price range. Unlike prior art systems, the auction system 10 via its search interface 92, includes a combine or include check-box 116 that allows a user to combine search criteria from the Basic Search box 94 as well as from the Attributes Search box 96. As described in more detail below, by checking the check-box 116, the user may either select or deselect inclusion of the search criteria defined or selected in the Basic Search box 94 when a “Find” button 118, associated with the Attribute Search box 96, is activated.

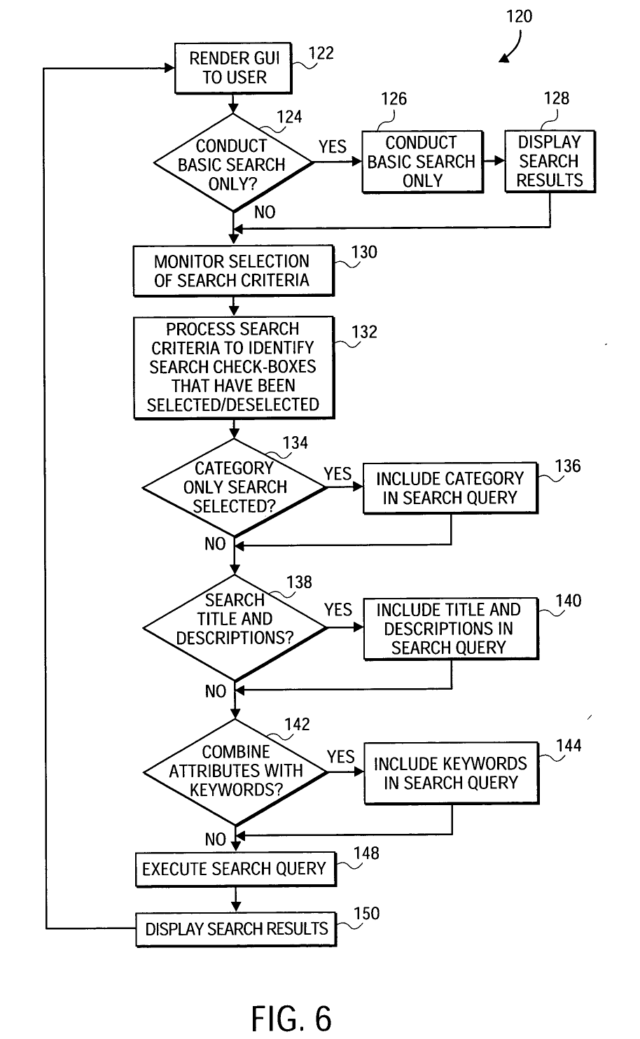

Referring in particular to FIG. 6, numeral 120 general indicates a method, in accordance with an exemplary embodiment of the invention, of searching a database using multiple search criteria. As shown at block 122, the GUI generation module 80 (see FIG. 4) generates the search interface 92 (see FIG. 5) that enables a user to search for any listings included in the database 36 (see FIG. 1). The user may select or elect to conduct a basic search only using the entry field 100 and the check-boxes 102, 106 in the Basic Search box 94 (see FIG. 5). If, as shown at decision block 124, a user selects to conduct a basic search only, then the search engine 78 conducts a search of the database 36 using the search criteria set out in the Basic Search box 94 only, (see block 126). Thereafter, the display search results module 88 displays the search results to the user in the display area 98 of the search interface 92 (see block 128). In certain embodiments of the invention, the user may then refine the search criteria in the Basic Search box 94 and conduct any number of searches using the keywords he or she enters into the entry field 100.

However, in addition to, or instead of, the basic search, the user may also elect to conduct a search wherein search criteria are defined in the Attribute Search box 96. In particular, the search query identification module 82 and the search query build module 84 may monitor selection of any one or more of the attributes 108 to 114, and build a search query to search the database 36 based on the attributes 108 to 114 (see block 130). Typically, the user may activate the Find button 118 to initiate the search and, thereafter, the search engine 78 processes the search criteria defined by the Basic Search box 94 and the the Attribute Search box 96. In particular, as shown at block 132 (see FIG. 6), the search query identification module 82 identifies which particular attributes 108 to 114 have been selected or deselected by the user.

The search query build module 84 may then build a search query for searching the database 36 based on the search criteria included in the Basic Search box 94 (first search criteria) and the Attribute Search box 96 (second search criteria). As shown at decision block 134, if the check-box 102 has been checked by the user, thereby to indicate that a search is to be conducted in a particular category only, then the search query build module 84 includes the category in the search query as shown at block 136. In a similar fashion, if the Title and Description check-box 106 has been checked by the user, then as shown at decision blocks 138 and 140 the Title and Description search criteria is included in the search query by the search query build module 84. Finally, in the embodiment depicted in the drawings, if the check-box 116 has been checked, thereby to identify that the user requires a combined search in which the search criteria of both the Basic Search box 94 and the Attribute Search box 96 are included (see block 142 and 144), then the search query build module 84 builds a search query that includes the search criteria specified in both the Basic Search box 94 and the Attribute Search box 96. However, if the check-box 116 is not checked, and the user activates the Find button 118, then the search query is built using only the attributes 108 to 114 that the user has selected. Likewise, if a Search button 146 of the Basic Search box 94 is activated by the user, then the search query build module 84 builds a search query which includes only the criteria set out in the Basic Search box 94.

After the search query build module 84 has built the search query, the search query execution module 86 executes the search query (see block 148 in FIG. 6) and, thereafter, at block 150 the search engine 78 displays the search results using the display search results module 88. The search results may be provided by the page and picture servers 12 and 14.

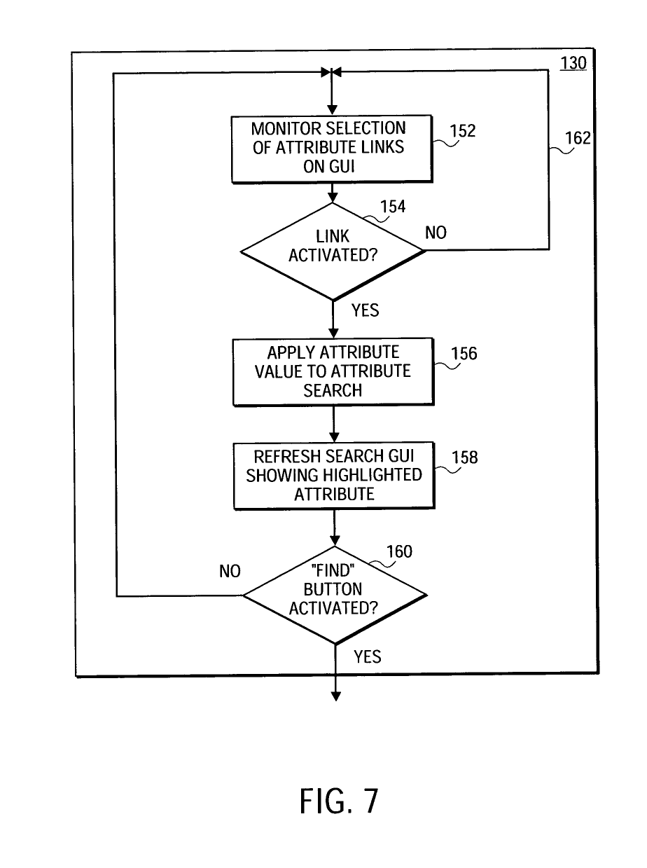

Referring in particular to FIG. 7, functionality of the method 120 shown at block 130 in FIG. 6 is shown in more detail. In particular, as shown at block 152 in FIG. 7, the search query identification module 82 monitors selection of the attributes 108 to 114 (which may be in the form of attribute links) in the Attribute Search box 96 and, as shown at block 154, when a link is activated the search query identification module 82 applies an attribute value to the attribute search as shown at block 156. Thereafter, the search query identification module 82 refreshes the search interface 92 so that the selected attribute is highlighted (see block 158).

In one embodiment, when the attributes are in the form of links, when a user clicks on a given attribute value link, this value may be applied to the attribute search. If the Find button 118 is activated, then as shown at decision block 160, the method 120 proceeds to block 132 in FIG. 6. If, however, the Find Button 118 is not activated, then the method 120 returns to block 152 to monitor the selection of further attributes 108-114 and/or check-boxes 102, 106 and 116. If no attributes are activated, the method 120 reverts to block 152 as shown by line 162 until the particular search criteria is selected.

It will be evident from the search interface 92 that a user may use the check-boxes 102, 106 and 116 to restrict or expand the scope of a search. For example, if the user wishes to search the entire database 36 (which may or may not correspond to an entire website hosting the network-based commerce facility) then the user may not check any of the check-boxes 102, 106 and 116 and activate the Search button 146. If, however, the user wishes to restrict a search to a particular category of listings in the database 36, he or she may check the check-box 102. Thus, the user may enter a different keyword in the entry field 100 and only the particular category is searched using the keyword. In a similar fashion, the check-box 116 may be checked to use further search criteria defined by the attributes 108 to 114. Thus, the exemplary check-boxes 102, 106 and 115 may allow the user to select and deselect search criteria from a listings search. Buttons to provide more or additional attributes may be provided in the Attribute Search box 94.

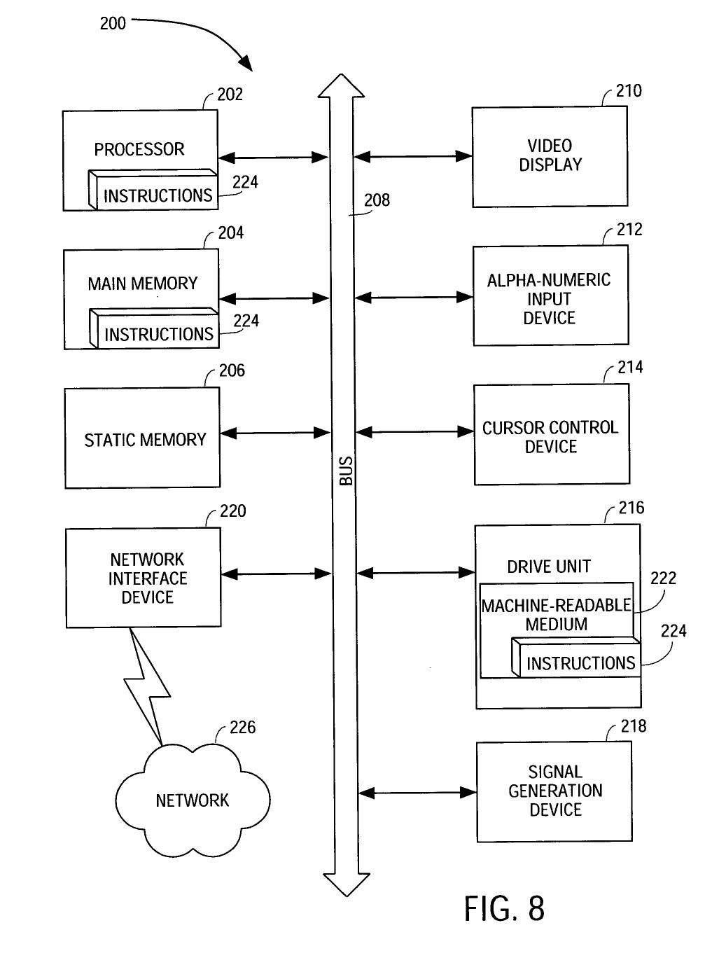

FIG. 8 shows a diagrammatic representation of machine in the exemplary form of a computer system 200 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 200 includes a processor 202, a main memory 204 and a static memory 206, which communicate with each other via a bus 208. The computer system 200 may further include a video display unit 210 (e.g., a liquid crystal display (LCD) or cathode ray tube (CRT). The computer system 200 also includes an alphanumeric input device 212 (e.g. a keyword), a cursor control device 214 (e.g. a mouse) a disk drive unit 216, a signal generation device 218 (e.g. a speaker) and a network interface device 220.

The disk drive unit 216 includes a machine-readable medium 222 on which is stored a set of instructions (software) 224 embodying any one, or all, of the methodologies described above. The software 224 is also shown to reside, completely or at least partially, within the maim memory 204 and/or within the processor 202. The software 224 may further be transmitted or received via the network interface device 220. For the purposes of this specification, the term “machine-readable medium” shall be taken to include any medium which is capable of storing or encoding a sequence of instructions for execution by the machine and that cause the machine to perform any one of the methodologies of the present invention. The term “machine-readable medium” shall accordingly be taken to included, but not be limited to; solid-state memories, optical and magnetic disks, and carriers wave signals.

Thus, a method and a system for searching a database using multiple search criteria which can be selected and deselected is provided with reference to specific exemplary embodiments. It will be evident that various modifications and changes may be made to these embodiments without departing from the broader spirit and scope of the invention. Accordingly, the specification and drawings are to be regarded in an illustrative rather than a restrictive sense. For example, the invention may also be applied in a peer-to-peer computing environment.

What we claim is:

1. A method to facilitate a search of a database utilizing multiple search criteria, the method including:
receiving first and second search criteria from a user; and
presenting the user with an option selectively to include and exclude each of the first and second search criteria from a search query run against the database.

2. The method of claim 1, which includes conducting a search of the database utilizing the search query, the search query including at least one of the first and second search criteria as included by the user.

3. The method of claim 1, which includes:
presenting a search interface to the user to receive the first and the second search criteria, the search interface providing the user with a limitation option to limit a scope of any search query including the first search criteria;
monitoring selection of the limitation option by the user; and
monitoring an indication from the user that indicates inclusion or exclusion of each of the first and second search criteria within the search query.

4. The method of claim 1, wherein the database forms part of a network-based commerce facility.

5. The method of claim 4, wherein the network-based commerce facility is a network-based auction facility and the first and the second search criteria are associated with listings of products up for auction on the auction facility.

6. The method of claim 5, wherein the network-based auction facility is a web-based auction facility, the method including rendering to the user a web page including:
a first search criteria section for receiving the first search criteria from the user; and
a second search criteria section for receiving the second search criteria from the user, the second search criteria being associated with one of a plurality of categories in which listings are arranged.

7. The method of claim 6, wherein the second search criteria section provides a plurality of optional search criteria at least one of which is selectable by the user to define the second search criteria.

8. The method of claim 5, which includes:
responsive to a first search request from the user, conducting a first search of the database to locate listings based on a first search query, wherein the first search query includes the first search criteria but not the second search criteria;
responsive to a second search request form the user, conducting a second search of the database to locate listings based on a second search query, wherein the second search query includes both the first and the second search criteria; and
responsive to a third search request from the user, conducting a third search of the database to locate listings based on a third search query, wherein the third search query includes the second search criteria but not the first search criteria.

9. The method of claim 1, wherein the first search criteria is a keyword that identifies at least one category of listings included within the database, and the second search criteria is an attribute associated with a listing stored in the database.

10. The method of claim 1, wherein the first search criteria is a keyword that identifies at least one category of listings included within the database, and the second search criteria identifies at least one sub-category of the at least one category.

11. The method of claim 3, wherein the search interface maintains a display of each of the first and second search criteria, regardless of whether the first and second search criteria are each selected by the user to be included within the search query.

12. A machine-readable medium embodying a sequence of instructions for facilitating a search of a database utilizing multiple search criteria, the instructions, when executed by a machine, cause the machine to:
receive first and second search criteria from a user; and
present the user with an option selectively to include and exclude each of the first and second search criteria from a search query run against the database.

13. The machine-readable medium of claim 12, wherein a search of the database is conducted utilizing the search query, the search query including at least one of the first and second search criteria as included by the user.

14. The machine-readable medium of claim 12, wherein:
a search interface is presented to the user to receive the first and the second search criteria, the search interface providing the user with a limitation option to limit a scope of any search query including the first search criteria;
selection of the limitation option by the user is monitored; and
an indication from the user is monitored that indicates inclusion or exclusion of each of the first and second search criteria within the search query.

15. The machine-readable medium of claim 12, wherein the database forms part of a network-based auction facility and the first and the second search criteria are associated with listings of products up for auction on the auction facility.

16. The machine-readable medium of claim 15, wherein the network-based auction facility is a web-based auction facility that renders to the user a web page including:
a first search criteria section for receiving the first search criteria from the user; and
a second search criteria section for receiving the second search criteria from the user, the second search criteria being associated with one of a plurality of categories in which listings are arranged.

17. The machine-readable medium of claim 16, wherein the second search criteria section provides a plurality of optional search criteria at least one of which is selectable by the user to define the second search criteria.

18. The machine-readable medium of claim 16, wherein:
responsive to a first search request from the user, a first search of the database is conducted to locate listings based on a first search query, wherein the first search query includes the first search criteria but not the second search criteria;
responsive to a second search request form the user, a second search of the database is conducted to locate listings based on a second search query, wherein the second search query includes both the first and the second search criteria; and
responsive to a third search request from the user, a third search of the database is conducted to locate listings based on a third search query, wherein the third search query includes the second search criteria but not the first search criteria.

19. The machine-readable medium of claim 12, wherein the first search criteria is a keyword that identifies at least one category of listings included within the database, and the second search criteria is an attribute associated with a listing stored in the database.

20. The machine-readable medium of claim 12, wherein the first search criteria is a keyword that identifies at least one category of listings included within the database, and the second search criteria identifies at least one sub-category of the at least one category.

21. The machine-readable medium of claim 14, wherein the search interface maintains a display of each of the first and second search criteria, regardless of whether the first and second search criteria are each selected by the user to be included within the search query.

22. A system to facilitate searching of a database using multiple search criteria, the system including at least one server to:
receive first and second search criteria from a user; and
present the user with an option selectively to include and exclude each of the first and second search criteria from a search query run against the database.

23. The system of claim 22, wherein a search of the database is conducted utilizing the search query, the search query including at least one of the first and second search criteria as included by the user.

24. The system of claim 22, wherein:
a search interface is presented to the user to receive the first and the second search criteria, the search interface providing the user with a limitation option to limit a scope of any search query including the first search criteria;
selection of the limitation option by the user is monitored; and
an indication from the user is monitored that indicates inclusion or exclusion of each of the first and second search criteria within the search query.

25. The system of claim 22, wherein the database forms part of a network-based auction facility and the first and the second search criteria are associated with listings up for auction on the auction facility.

26. The system of claim 25, wherein the network-based auction facility is a web-based auction facility that renders to the user a web page including:
a first search criteria section for receiving the first search criteria from the user; and
a second search criteria section for receiving the second search criteria from the user, the second search criteria being associated with one of a plurality of categories in which listings are arranged.

27. The system of claim 26, wherein the second search criteria section provides a plurality of optional search criteria at least one of which is selectable by the user to define the second search criteria.

28. The system of claim 27, wherein:
responsive to a first search request from the user, a first search of the database is conducted to locate listings based on a first search query, wherein the first search query includes the first search criteria but not the second search criteria;
responsive to a second search request form the user, a second search of the database is conducted to locate listings based on a second search query, wherein the second search query includes both the first and the second search criteria; and
responsive to a third search request from the user, a third search of the database is conducted to locate listings based on a third search query, wherein the third search query includes the second search criteria but not the first search criteria.

29. The system of claim 22, wherein the first search criteria is a keyword that identifies at least one category of listings included within the database, and the second search criteria is an attribute associated with a listing stored in the database.

30. The system of claim 22, wherein the first search criteria is a keyword that identifies at least one category of listings included within the database, and the second search criteria identifies at least one sub-category of the at least one category.

31. The system of claim 24, wherein the search interface maintains a display of each of the first and second search criteria, regardless of whether the first and second search criteria are each selected by the user to be included within the search query.

32. A system to facilitate searching of a database using multiple search criteria, the system including:
means to receive first and second search criteria from a user; and
means to present the user with an option selectively to include and exclude each of the first and second search criteria from a search query run against the database.
